(19) United States
(12) Patent Application Publication
(10) Pub. No.: US 2012/0135149 A1
(43) Pub. Date: May 31, 2012

(54) IMPROVED ANTI-BIOFOULING COATING

(76) Inventors: Pascal Josef Paul Buskens, Heerlen (NL); Jacobus Adriaan Antonius Vermeulen, Born (NL); Ronnie de Rijk, Nuth (NL); Jens Christoph Thies, Eijsden (NL); Jun Qiu, Weert (NL)

(21) Appl. No.: 13/257,850

(22) PCT Filed: Mar. 25, 2010
(86) PCT No.: PCT/EP10/53924

§ 371 Date: Dec. 6, 2011

(30) Foreign Application Priority Data
Mar. 5, 2009 (EP) 09156146.4

(51) Int. Cl. B05D 5/00; C09D 5/16

(52) U.S. Cl. 427/385.5; 523/122

(57) ABSTRACT

The invention relates to a coating material suitable for providing a substrate with an anti-biofouling coating, the coating material comprising a macromolecule comprising: (A) a macromolecular scaffold comprising a reactive group capable of undergoing a Michael type reaction between a Michael type acceptor group and a Michael type donor group, (B) at least one functional moiety attached to the macromolecular scaffold, said at least one functional moiety comprising a hydrophilic moiety, wherein the functional moiety is derivable from a Michael type reaction, involving the reactive group on the macromolecular scaffold and a reactive hydrophilic moiety and (C) at least one moiety capable of crosslinking the coating material.

The invention relates to the coating of substrate surfaces in order to prevent biofouling of such a substrate, and to coating materials suitable for use therein.

Objects in contact with water, especially those made of synthetic materials, are generally prone to suffering from an undesirable accumulation of biologically derived organic species, be it from protein adsorption, bacterial adsorption and subsequent spreading, or thrombosis. This is commonly termed ‘biofouling’ and it generally occurs due to contact with water, or other aqueous fluids, comprising biological species (hereinafter referred to as biofluids'). The adsorption and accumulation of biological species incurred upon biofouling generally is irreversible and non-specific.

Biofouling occurs in a variety of situations. E.g., ships' hulls are prone to suffering from biofouling. Medical devices (e.g. artificial implants, catheters, contact lenses), in contact with body fluids can accumulate biological species (e.g. bacteria, proteins, cells) from those body fluids. Another example of typical surfaces that may suffer from biofouling, is that of surfaces used in water purification plants.

Biofouling can have serious undesirable consequences. For example, in the medical area bacterial infections via catheters may be caused by biofouling and in industry the clogging of filters, accumulation of organic material on surfaces etc also causes problems

A particular drawback of biofouling is that occurring in laboratories where biofluids are tested. In biochemical analysis, diagnostics, etc., many synthetic, frequently disposable devices are used; as well as in preanalytical handling equipment such as storage containers before the drawing of samples. In these instances it is highly detrimental for the surfaces of these devices to be prone to biofouling, since the adsorption of biomaterials from the biofluids in contact therewith can affect test results, e.g. the content of the biofluid is affected as biomaterial is adsorbed and thus effectively taken out of the fluid, and/or the natural conformation of biological species (e.g. the three-dimensional structure of proteins) can be affected by the interaction with synthetic surfaces, leading to a loss of bioactivity. This problem is especially prominent if the amounts of species to be tested is low, e.g. as in microtiter plates used in analytical research laboratories or clinical diagnostic testing laboratories.

E.g., in the event of unspecific binding in microplates, the covalent bonding to the surface is difficult to control, frequently resulting in splotchy coverage, resulting in irregular binding, bio-activity loss (sensitive monoclonal antibodies sometimes lose activity due to conformational changes caused by the interaction with the hydrophobic surface), and low reproducibility by trial-and-error. This unspecific binding can also take place in bacterial cultures, yeast cultures, plasmid purification, cDNA storage, storage of genome banks, storage of cryocultures, (e.g. cells/cell cultures), protein analysis, protein therapeutics discovery & development, stem cell discovery, protein kinase, scintillation proximity assays, etc.

It is recognized that the foregoing problems, which are particularly widespread in relation to hydrophobic surfaces, can be addressed by technologies to render such surfaces hydrophilic. Many biological species comprise hydrophobic moieties, and will thus be repelled by a hydrophilic coating (just as they are prone to be attracted by the normally hydrophobic surfaces of the typically synthetic surfaces referred to above). The problem is not limited to hydrophobic surfaces, and can occur with any surface, and particularly also with charged surfaces (as many biological molecules also comprise charged groups).

Whilst different hydrophilic materials, particularly polymers, are possible, the currently most favored materials are those comprising polyethyleneoxide (PEO) chains, i.e. polymers based on polyethylene glycol (PEG)

Several different methods exist serving to attach the hydrophilic materials, typically PEG, to the generally hydrophobic surfaces of objects that are to be prevented from biofouling when in contact with biofluid.

One such technology is based on block copolymers. Thus, U.S. Pat. No. 6,093,559 discloses a method to reduce the level of protein binding of hydrophobic polymer surfaces by providing a coating solution composed of a solvent and a non-ionic surfactant having an HLB number of less than 5 and at least one hydrophilic element that can extend into an aqueous solution. The surfactant typically is an ethylene oxide/propylene oxide block co-polymer.

WO95/06251 makes use of triblock copolymers comprising a poly ethylene oxide block, a reactive-groups functionalized polyethylene oxide block, and a polypropylene oxide block. A drawback to the foregoing technologies, which are based on creating physically deposited layers are that the block copolymers thus applied contain components that are prone to leach into the biofluid, which is a clear drawback e.g. for analytical purposes (Clin Chim Acta 2007; 378 (1-2): 181-193). A further example of a non-biofouling product is the Corning NBS Microplate (Catalog #3676). This product uses a surfactant to provide non-biofouling properties and this surfactant can also affect the results of subsequent assays. It is hypothesized that the non-biofouling surfactant leach out of the coatings and in to the samples where they affect the results of subsequent tests.

Another technology is based on the formation of self-assembled monolayers (SAM), by applying on a surface polymers one end of which has a special affinity for the surface. This involves, e.g., silane coupling agents. A reference in this respect is Seongbong Jo and Kinam Park, Biomaterials 21 (2000) 605-616. As to SAM, several studies on gold substrates with thiolated PEG derivatives have been reported. E.g.: Wang et al., J. Phys. Chem., B 101 (1997) 9767; Harder et al., J. Phys Chem. B 102 (1998) 426. Those technologies are difficult to apply in the case of relatively large surfaces without defects, on an industrial scale.

Yet another technology is based on ionic bonding. This requires the hydrophobic surface to be ionically charged, e.g. (+), so as to enable it to bind to an ionic group of opposite charge, e.g. (−), contained in the hydrophilic polymer (PEO) to be attached to the surface. This type of bonding is process-intensive, as it requires a surface modification as well as appropriately functionalizing the hydrophilic polymer.

Another problem with existing biofouling coatings is that to achieve the required mechanical properties, such as scratch resistance, the use of nanoparticles have been required, such as those disclosed in WO2006/016800. While, these coatings have good mechanical properties, their more rigid structure can be prone to cracking and/or delaminating from the substrate, thereby making the coatings prone to variations in their anti-biofouling performance.

In view of the foregoing, it is desired to provide a material for anti-biofouling coatings that, in addition to comprising anti-biofouling properties, can be easily applied to a substrate, has good adhesion to the substrate, is resilient to cracking and delamination, and its functional properties may be conveniently customized to suit the substrate properties and the biofouling environment.

Clearly, high surface hydrophilic coverage in a controlled and reproducible way is the key to form a useful anti-biofouling coating.

In order to better address one or more of the foregoing desires, the invention provides a coating material suitable for providing a substrate with an anti-biofouling coating, the coating material comprising a macromolecule comprising:
(A) a macromolecular scaffold comprising a reactive group capable of undergoing a Michael type reaction between a Michael type acceptor group and a Michael type donor group,
(B) at least one functional moiety attached to the macromolecular scaffold, said at least one functional moiety comprising a hydrophilic moiety, wherein the functional moiety is derivable from a Michael type reaction, involving the reactive group on the macromolecular scaffold and a reactive hydrophilic moiety and
(C) at least one moiety capable of crosslinking the coating material.

The moiety capable of crosslinking the coating material can be comprised in the macromolecular scaffold or can be a further functional moiety attached to the macromolecular scaffold.

It has been surprisingly found that a macromolecular scaffold in combination with Michael type reactive groups, as defined in the present invention, is able to produce coatings with anti-fouling properties, while having good functional properties which are suitable for a broad range of anti-fouling applications. Furthermore, the coating material can be produced with a high degree of structural and functional consistency, making the coating materials particularly suitable for biomedical applications.

A further advantage of the resulting coating is that it shows good reproducible anti-biofouling results on a wide spectrum of substrates.

In another aspect, the invention provides an article comprising a non-biofouling coating comprising a coating material as previously described.

In a further aspect, the invention provides for use of a coating material, as described in the present invention, in an anti-biofouling coating, wherein the biofouling refers to the non-specific adhesion of proteins, peptides, nucleic acids, enzymes, antibodies, cells and micro-organisms, mixtures of the above and blood.

In a still further aspect, the invention provides a method for providing a substrate with a non-bioufouling coating, comprising the following steps:
(a) providing a film-forming formulation comprising a coating material as described in the present invention;
(b) applying the formulation to a substrate using any suitable application method, e.g. spray-coating, dip-coating, aspiration coating, ink-coating (preferably ink jet coating)
(c) evaporating substantially all volatiles;
(d) cross-linking using any suitable cross-linking technique like UV curing, electronbeam curing, thermal curing.

Alternatively, step (b) may be amended such that the coating is cast to form a film which may then be applied to substrate using an adhesive agent (step (e)).

In yet a further aspect, the invention provides a system for customising the functionality of a coating material comprising the steps of:
(A) providing a coating material according as previously described, wherein the macromolecule comprises at least one reactive group capable of undergoing a Michael type reaction between a Michael type acceptor group and a Michael type donor group;
(B) evaluating the functional performance of the coating material against a predetermined specification;
(C) adding a functional moiety to react with at least a portion of the reactive group, based upon the evaluated functional performance in step (B); and
(D) repeating steps (B) and (C) until the functional performance of the coating material satisfies the predetermined specification.

In another aspect of the present invention, there is provided a use of a macromolecule or macromolecular scaffold as described in the present invention in an anti-biofouling coating.

The invention, in a broad sense, is based on the use of a macromolecular scaffold having hydrophilic moiety attached thereto in providing an anti-biofouling coating.

### Macromolecular Scaffold

A macromolecular scaffold is a structure having sufficient molecular mass to attach a hydrophilic moiety possessing good anti-fouling functionality. In addition, the structure and/or composition of the macromolecular scaffold positively contributes towards good chemical and mechanical properties of the coating material and/or is able to attach further chemical and/or mechanical enhancing moieties to its framework.

The macromolecular scaffold is preferably a linear, branched or a dendritic molecule. The molecular scaffold may be derived from organic or organic—inorganic (hybrid) oligomers or polymers.

An example of a linear oligomer or polymer hybrid macromolecular scaffold is an inorganic oligomer or polymer, (eg. siloxane based backbone) comprising pendant groups which include at least one reactive group which is capable of participating in a Michael type reaction (i.e comprising Michael type acceptor or donor group(s).).

A further example of a hybrid polymer is polydimethylsiloxane modified chitosan as disclosed in Polydimethylsiloxane modified chitosan. Part III: Preparation and characterization of hybrid membranes. Enescu, Daniela; Hamciuc, Viorica; Ardeleanu, Rodinel; Cristea, Mariana; loanid, Aurelia; Harabagiu, Valeria; Simionescu, Bogdan C. Department of Macromolecules, “Gh. Asachi” Technical University, Iasi, Rom. Carbohydrate Polymers (2009), 76(2), 268-278. Publisher: Elsevier Ltd

An example of a branched oligomer or polymer hybrid macromolecular scaffold is a branched inorganic oligomer or polymer, (e.g. branched siloxane based polymer or oligomer) comprising pendant groups or chain extension groups which include at least one reactive group which is capable of participating in a Michael type reaction (i.e. comprising Michael type acceptor or donor group(s).)

An example of a linear oligomer or polymer organic macromolecular scaffold is a linear organic oligomer or polymer chain comprising pendent groups which include at least one reactive group which is capable of participating in a Michael type reaction (i.e. comprising Michael type acceptor or donor group(s).)

Examples of a macromolecular scaffold comprising branched organic oligomers or polymers include dendritic molecules, including hyperbranched polymers which include at least one reactive group which is capable of participating in a Michael type reaction (i.e. comprising Michael type acceptor or donor group(s).)

A main criterium of the macromolecular scaffold is that it is of sufficient molecular mass to possess the required mechanical properties required in anti-bio-fouling coatings and that the macromolecular scaffold is capable of attaching hydrophilic moiety thereto and any other functional moiety through a Michael type addition or reaction. To satisfy this criterium, the macromolecular scaffold possesses at least one Michael type acceptor and/or Michael type donor.

For convenience, Michael type donor and Michael type acceptor may be described as a Michael type reactive group, in which, unless otherwise indicated, the Michael type reactive group on the macromolecular scaffold are complimentary to the Michael type reactive groups on the functional moiety, which is inclusive of the reactive hydrophilic moiety.

As used herein, the term “macromolecular” or “macromolecule” denotes a molecule, or portion thereof, having a large molecular mass, in particular a molecular mass of 200 g/mol or more, preferably 500 g/mol or more, more preferably 1000 g/mol or more, and most preferably 1500 g/mol or more. A relatively high molecular mass may be desirable for a particularly low shrink upon curing, conveniently at least 1800 g/mol, more conveniently at least 2500 g/mol, most conveniently at least 3000 g/mol. To ensure that the viscosity of the coating material is sufficient low to enable it to be readily and uniformly applied to a substrate, the molecular mass of the macromolecule of the present invention is preferably less than 15,000 g/mol, more preferably less than 12,000 g/mol, even more preferably less than 10,000 g/mol and most preferably less than 8,000 g/mol.

The macromolecule compound may be a single compound (for example prepared by an organic synthesis in one or more steps), a polymeric material (for example prepared by a suitable polymerisation method) comprising a mixture of compounds with different numbers of repeat units, a polymerisable macromolecular compound and/or any suitable mixtures thereof. If the macromolecule of the invention is polymeric (i.e. obtained by polymerisation and having a polydispersity of greater than 1), then the molecular weight values given herein will be a number average molecular weight (Mₙ) of such polymers of the invention.

In one embodiment, the macromolecular scaffold comprises a dendritic molecule. The dendritic molecules preferably comprise hyper-branched polymers and/or oligomers or a structurally perfect molecule i.e. a macromolecular variant of dendrimers or dendrons. The structurally perfect dendimer structure evolves around a core atom or building block molecule with repeating connection of branch group that branch again and again until an almost globular shape with a dense surface is reached. A manifold of different styles and designs of cascade molecules has so far been reported and the yearly number of publications on this topic is ever increasing since the first cascade molecules were reported twenty years ago.

In 1979, Denkewalter et al. released a patent on branched structures based on amino acids. Dendritic macromolecules such as polyamidoamine (PAMAM) were described by Tomalia and polyaryl ether by Fréchet. Tomalia revived the concept of highly branched dendrimer. In addition, these periphery-functionalized hyperbranched dendrimers have the linking element between small (organic) molecules and high molecular mass macromolecules, to form nanometer-size molecular arrays; they are the ideal building blocks for nanoarchitecture. Some commercial applications have been realised, e.g. in medical diagnostics, and many more are presently envisaged.

Preferably the dendritic molecule is a hyper-branched polymers and/or oligomers as these molecules provide good functionality and are more easily produced than structurally perfect dendimers.

Preferred dendritic molecules can be described as hyperbranched polymers that emanate from a central core, have a defined number of generations and reactive and functional end groups, and are synthesized in a stepwise way by a repetitive reaction sequence. The syntheses described so far are either convergent, in which case discrete organic compounds are synthesized, or divergent, in which case the construction of dendrimers can be regarded as a step polymerization with polydispersities of almost 1.

Examples of dendritic molecules which are suitable to be used as macromolecular scaffolds, or a precursor thereof, may be found in the following references: D. A. Tomalia, A. M. Naylor, W. A. Goddard III, Angew. Chem. 1990, 102, 119; Angew. Chem. Int. Ed. Engl. 1990, 29, 138-175; D. A. Tomalia, H. Baker, J. Dewald, M. Hall, G. Kallos, S. Martin, J. Roeck, J. Ryder, P. Smith, Polym. J. Tokyo 1985, 17, 117-132; C. J. Hawker, J. M. J. Fréchet, J. Am. Chem. Soc. 1990, 112, 7638; G. R. Newkome, X. Lin, Macromolecules 1991, 24, 1443; G. R. Newkome, A. Nayak, R. K. Behera, C. N. Moorefield, G. R. Baker, J. Org. Chem. 1992, 57, 358; T. M. Miller, E. W. Kwock, T. X. Neenan, Macromolecules 1992, 25, 3143; A. W. van der Made, P. W. N. M. van Leeuwen, J. Chem. Soc. Chem. Commun. 1992, 1400; A. Morikawa, M. Kakimoto, Y. Imai, Macromolecules 1991. 24, 3469., van Benthem et al., Macromolecules 2001, 34, 3559-3566; Froeling, J. Polym. Sci. Part A: Vol 42 (2004), 3110-3115; Tomalia et al., Polymer Journal, Vol 17., No. 1 pp 1117-132 (1985); WO 99/61810

In a preferred embodiment, the macromolecular scaffold comprises building blocks based on cyclic anhydride or dicarboxylic acid, and hydroxy alkyl amine and/or ester branching groups.

Hyperbranched polymers which are suitable to be used as macromolecular scaffolds, or a precursor thereof, include Hybrane (DSM), Boleorn (Perstorp), Multi-functional (meth)acrylates (Sartomer), Hyperbranched polyglycerol (HyperPolymers) and Priostar (Dendritic Nanotechnologies).

Dendrimers can be generally described as repeatedly branched species. Low-molecular mass dendrimers are typically dendrimers, in which a core molecule is provided with branch molecules, and these branch molecules in turn are provided with further branch molecules, the result being a perfect, symmetric three-dimensional structure (the aforementioned hyperbranched polymers and/or oligomers are not perfect symmetric 3-dimensional structures). A variant is a dendron, in which the core is replaced by a focal point, which on one side keeps an active moiety, while on all other sides the repeated branches extend.

Dendrimers which are suitable to be used as macromolecular scaffolds, or a precursor thereof, include commercially available molecules: such as Astramol (Poly(propyleneimine)) (DSM), Starburst (Dendritech).

In describing preferred macromolecules, especially comprising dendritic molecules, the following parts may be distinguished: a building block (which serves as a core from which a divergent synthesis starts), a branching group (which serves to create the desired e.g. hyperbranched structure), and a periphery (which forms the terminal chains of the branches).

Under the definition of a molecular scaffold and a functional moiety, the molecular scaffold includes all parts of the macromolecule excluding a functional moiety attached by a Michael type reaction. In instances in which the functional moiety is attached to the molecular scaffold through more than one Michael type reaction, then the functional moiety is considered to be the portion from and including the last Michael type reactive group prior to the terminal group on the functional moiety. As such, the branching group as described in terms of a macromolecule may comprise part of the molecular scaffold and part of the functional moiety.

### Michael Type Reactions

Michael type reactions or additions refers to a conjugate addition reaction in which a carbanion or nucleophile (Michael type donor) is reacted with an activated alkene, including an a; β-unsaturated compound (Michael type acceptor). The term Michael type reaction is inclusive of the term Michael reaction which originally encompassed the addition of only carbon donors.

The Michael type donors may be carbon nucleophiles or non-carbon nucleophiles. Suitable non carbon nucleophiles preferably include a donor atom selected from a group consisting of nitrogen, phosphorous, arsenic, oxygen, sulphur, tin and selenium. Suitable compounds containing non-carbon nucleophiles include alcohols, alkoxides, primary and secondary amines, hydrazines, hydroxylamines and their derivatives, phosphines, sulfides, thiols, thiolates, carboxylates, phenols, phenolates, thiophenols, thiophenolates, selenides, and tin derivatives. Suitable Carbon nucleophiles include carbanions from beta-ketoesters, malonate esters, trialkylboranes, alkylsilyl derivatives, enolates, silyl enols, enamines, and the anions in Scheme 1 of U.S. Pat. No. 6,887,517, which is included herein by reference.

In a preferred embodiment the Michael-type donor is an amine and most preferably a primary amine. The Michael-type reaction may take place directly or be catalyzed through the use of a base, as known in the art (e.g. triethylamine). For secondary amines the reaction can be accelerated by using high temperatures or a base catalyst. In a particular embodiment, the Michael-type donor is a secondary amine, as this donor reacts quickly and effectively completely with Michael type acceptors, preferably acrylic compounds, thereby enabling the ratio of hydrophilic moiety to the functionality of other moieties of the macromolecule to be effectively controlled.

In the context of the present invention, the term “Michael acceptor” refers to any activated alkene compound which is capable of reacting with a nucleophile in a conjugate addition reaction such as the so called Michael type addition.

Examples of Michael type acceptors are well known and any compound of this type is suitable for use in the present invention. Michael acceptors include α,β-unsaturated esters, α,β-unsaturated amides, α,β-unsaturated carboxylic acids, α,β-unsaturated acrylics nitriles, α,β-unsaturated aldehydes and α,β-unsaturated ketones. Examples of α,β-unsaturated carbonyls are acrolein, mesityl oxide, acrylic acid and maleic acid.

In a preferred embodiment, the Michael type acceptor is selected from the group consisting of vinylketones, acrylates, methacrylates, vinyl sulfones, acryl amides, allenic esters, vinylsulphonates, vinyl phosphonates, crotonic acid esters, vinyl sulfoxide and combinations thereof. More preferably, the Michael type acceptor is selected from the group consisting of acrylates, methacrylates, acryl amides and combinations thereof.

In a further embodiment, the Michael type acceptor is selected from the group consisting of: trimethylolpropane tri(meth)acrylate (TMPT(M)A), Hexanedioldi(meth)acrylate(HDD(M)A), dipropyleneglycoldi(meth)acrylate (DPGD(M)A), tripropyleneglycoldi(meth)acrylate(TPGD(M)A), Neopentylglycoldi(meth)acrylate (NPGD(M)A), pentaerythritoltetra(meth)acrylate (PET(M)A), pentaerythritoltri(meth)acrylate (PET3(M)A), idodecyl(meth)acrylate (ID(M)A), Glycedyl(meth)acrylate, Ethoxyethoxyethyl(meth)acrylate (EOEOE(M)A), Glycerolpropoxytri(meth)acrylate (GPT(M)A), isobornyl(meth)acrylate (iBo(M)A), isooctyl(meth)acrylate, tridecyl(meth)acrylate, caprolacton(meth)acrylate, nonylphenol(meth)acrylate, Allyl(meth)acrylate, Phenoxyethyl(meth)acrylate (PE(M)A), Cyclohexanedimethanoldi(meth)acrylate, diethyleneglycol-di(meth)acrylate, butanedioldi(meth)acrylate, BisphenolA di(meth)acrylate, dipentaerythritolhexa(meth)acrylate, Polyethyleneglycoldi(meth)acrylate (PEGD(M)A), Methoxypolyethyleneglycolmono(meth)acrylate, polypropyleneglycoldi(meth)acrylate, tetrahydrofurfuryl(meth)acrylate, tris(2-hydroxyethyl)isocyanurate tri(meth)acrylate, Stearyl(meth)acrylate, lauryl(meth)acrylate, phenol(meth)acrylate, ditrimethylolpropanetetra(meth)acrylate (diTMPT(M)A) and hydroxylethyl(meth)acrylate (HE(M)A) and combination thereof.

### Functional Moieties

The functional moiety is preferably a molecular chain (organic and/or inorganic), which may be linear or branched and which comprises at least one Michael type reactive group. Preferably the functional moiety is a molecular chain having a functional component and a component comprising at least one Michael type reactive group, wherein the functional component and the component comprising at least one Michael type reactive group are at opposing ends of the molecular chain. Under this configuration, the functional component typically forms part of the periphery of the macromolecule, where it can interact with its environment (e.g. substrate, biofluid)

In one embodiment of the present invention, the functional moiety comprises a Michael type donor and the reactive group of the macro molecular scaffold comprises a Michael type acceptor. It will be appreciated that the functional moiety may alternatively comprise a Michael type acceptor and the reactive group of the macro molecular scaffold comprise a Michael type donor. Indeed, the functional moiety and reactive group of the macromolecular scaffold may both comprise a mixture of Michael type donor and acceptor groups. However, this embodiment is generally not preferred due to the increased propensity of internal cross linking of the macromolecular scaffold or the formation of functional moieties separate from the macromolecular scaffold, thereby increasing the leachability of the cured coating material.

In the macromolecules of the present invention, one generally distinguishes at least two distinct structural moieties, i.e. a core (macromolecular scaffold) and a periphery (functional moieties including hydrophilic moiety). In the present invention, the hydrophilic moiety is necessarily located on the periphery of the macromolecule, however other optional structural moieties (e.g. a hydrophilic moiety; a moiety capable of bonding to a substrate and moiety capable of cross-linking the coating composition), can both be present in the macromolecular scaffold as well as in the attached functional moieties.

For the purposes of the present invention, the term “bonding to a substrate” encompasses adhesion and absorption to the substrate.

### Hydrophilic Moieties

It is possible that the macromolecular scaffolds are grafted with all kind of hydrophilic moieties via a Michael type reaction. A hydrophilic moiety (preferably a polymer chain) that dissolves in water at least one temperature between 0 and 100° C. Preferably a moiety is used that dissolves in water in a temperature range between 20 and 40° C. Preferably the hydrophilic moiety dissolves for at least 0.1 gram per litre of water, more preferably for at least 0.5 grams per litre, most preferably for at least 1.0 gram per litre. For determining the solubility in water the moiety are taken not comprising the groups for grafting the moiety (i.e. Michael reactive groups) or, for example when the moiety is a polymer, any other group that is attached to the polymer after the polymerisation, for example an ionic group. Preferably the solubility is determined in water having a pH of between 3 and 10, more preferably in between 5.5 and 9, most preferably having a pH of 7.

The polymer chain may comprise one monomer species (homopolymer), or more species (copolymer) arranged in a random manner or in ordered blocks.

The hydrophilic moieties comprised in the macromolecules of the invention preferably comprises monomer units selected from the group consisting of ethylene oxide, (meth)acrylic acid, (meth)acrylamide, vinylpyrrolidone, 2-hydroxyethyl(meth)acrylate, phosphorylcholine, glycidyl(meth)acrylate, saccharides and combinations thereof. In a preferred embodiment the hydrophilic moieties comprise poly ethylene oxide (i.e. PEG).

The reactive hydrophilic moiety preferably comprises:
(A) a reactive portion comprising a Michael type donor group comprising a nitrogen donor atom (or a sulphur donor atom (e.g. thiol group)); and a
(B) hydrophilic portion comprising a poly(ethylene oxide) group located in the peripheral portion at an opposing end to the donor group.

In an exemplary embodiment the reactive hydrophilic polymer is a poly(alkylene oxide)amine, wherein the alkylene oxide component comprised at least 50 wt %, preferably at least 80 wt %, even more preferably at least 95 wt % and most preferably at least 99 wt % poly(ethylene oxide), relative to the total weight of the poly(alkylene oxide). The higher the poly(ethylene oxide), the higher the hydrophilicity of the resulting hydrophilic moiety.

Exemplary examples of a reactive hydrophilic moiety are polymers comprising an amine terminal group and which comprises poly(ethylene oxide), such as polyetheramines known by the tradename Jeffamine®, preferably the M series, available from Huntsman Corporation. Preferably, the polyetheramines are a monoamine (although diamines and triamines may be used in alternative embodiments) having a molecular mass of approximately 500 to 5000, preferably 1000 to 3000, and wherein the molar ratio of ethylene oxide to propylene oxide in the polyether backbone is preferably at least 3 to 1, more preferably at least 5 to 1 and most preferably at least 10 to 1. The higher the ratio of ethylene oxide to propylene oxide is, the higher the hydrophilicity of the reactive hydrophilic polymers. Polyetheramines, as previously described, but having a ethylene oxide to propylene oxide in the polyether backbone of preferably less than 1 to 3, more preferably at least 1 to 6 and most preferable at least 1 to 10 may be used as reactive hydrophobic polymers. These functional moieties have low viscosity, low colour and good toughness which make them suitable in anti-fouling coating materials of the present invention.

One of the typical advantages that the coating imparts to the coated object are very good anti-biofouling properties of the coating, resulting from the hydrophilicity of the polymer chain. These properties increase with increasing concentration and length of hydrophilic polymer chain at the surface of the coating.

Preferably the chains of the hydrophilic polymer comprise at least an average of 5 monomeric units, more preferably the polymer comprises at least an average of 7 monomeric units, still more preferably the polymer comprises at least an average of 10 monomeric units, even still more preferably the polymer comprises at least an average of 15 monomeric units, and most preferably the polymer comprises at least an average of 20 monomeric units.

The concentration of hydrophilic polymer chains may, for example, be increased by increasing the density of grafted polymers to the dendritic molecular precursor or by increasing the length of the hydrophilic polymer chains.

Preferably, each macromolecular scaffold supports (i.e. has attached thereto) at least one hydrophilic polymer chain, more preferably at least 2, even more preferably at least 4, and most preferably at least 6 hydrophilic polymer chains. Preferably, the number of hydrophilic polymers chains attached to each macromolecular scaffold in no more than 12, more preferably no more than 10 and most preferably no more than 8. Higher numbers of hydrophilic chains per macromolecular scaffold result in higher viscosities of the coating material, which makes the application of a homogeneous coating more difficult.

Preferably, the coating composition comprises a macromolecule comprising:
(A) 10 to 90 parts by weight of a macromolecular scaffold;
(B) 10 to 90 parts by weight of a hydrophilic moiety attached to the macromolecular scaffold via a Michael type reaction as previously described; and
(C) 0-90 parts by weight of a moiety capable of crosslinking the coating material
(D) 0 to 50 parts by weight of a moiety capable of bonding to a substrate and/or an anti-microbial moiety,
wherein (A)+(B)+(C)+(D) is 100 parts by weight.

In embodiments requiring relatively high mechanical properties, the macromolecule scaffold (A) content is preferably at least 40 parts by weight and more preferably at least 50 parts by weight, while the hydrophilic moiety (B) is no more than 60 parts by weight and preferably no more than 50 parts by weight.

In embodiments requiring relatively high anti-fouling properties, the macromolecule scaffold (A) content is preferably no more than 30 parts by weight and more preferably no more than 20 parts by weight, while the hydrophilic moiety (B) is at least 60 parts by weight and preferably at least 70 parts by weight.

For obtaining good anti-fogging properties polymer chains having a relatively short length (e.g. molecular mass of 5000 g/mol, preferably 4000 g/mol) are preferred.

### Other Functional Moieties

An advantage of forming a macromolecular scaffold comprising Michael type reactive groups which are capable of taking part in a Michael type reaction is the same macromolecular scaffold may be used as the intermediate for a variety of macromolecules, with each macromolecule having a different functionality depending upon its specific application.

Through these Michael type reactive groups, the macromolecular scaffold may be loaded with a variety of functional moieties including:
hydrophobic moieties capable of bonding to a hydrophobic surface, preferably comprise poly(propylene oxide);
anti-microbial moieties which, for example, comprises a quaternary amine and or anti-microbial peptides and/or anti-biotic compounds.

The addition of further functional moieties is preferably achieved through the Michael type reaction, although it will be understood that a portion of the functional moieties may be attached using other grafting techniques. By producing a macromolecular scaffold with a predefined number of Michael type acceptor or Michael type donors, additional functional groups, comprising the appropriate Michael type donors or Michael type acceptors, may be conveniently attached through Michael type addition.

It is also possible, if desired, to attach one or more further functionalities to the macro molecular scaffold, e.g., hydrophilic chains or branches in one direction, hydrophobic chains or branches in another direction, and, e.g., ionically charged chains or branches in yet another direction.

It will be understood that if the macromolecular scaffold is to participate in a functional capacity, the structure of the macromolecule should be such as to be capable of exposing the macromolecular scaffold. Thus, in one embodiment, the macro molecular scaffold is hydrophobic (and therewith capable of physical interaction with a hydrophobic substrate). In the aqueous environment of a biofluid, and in the presence of a hydrophobic substrate, the hydrophilic chains of the periphery will extend into the water, all in generally the same direction, i.e. pointing away from the hydrophobic surface, thus exposing the hydrophobic macromolecular scaffold to said surface. In another embodiment, the macromolecular scaffold is capable of being ionically charged, e.g. with quaternary ammonium groups, and thus rendered capable of bonding interaction with a charged substrate.

In a preferred embodiment, in addition to the hydrophilic moiety, at least one further type of functional moiety is attached to the macromolecular scaffold. These functional moieties are preferably moieties capable of bonding to the surface of the substrate, which may include reactive moieties (e.g. coupling groups or ionic groups) that can bond to an appropriately activated surface (e.g. a hydrophilic or hydrophobic surface provided with ionic charges).

### Substrate Adhesive Promoter Moiety

Preferably, the moiety capable of bonding to the surface is a hydrophobic moiety, so as to enable bonding to hydrophobic surfaces. This moiety can form part of the molecular scaffold, as mentioned above, but it can also be comprised in the attached functional moieties attached there from. In the latter embodiment, the molecular scaffold does not need to be selected for hydrophilic or hydrophobic characteristics, and mainly has a function as a carrier (e.g. the stem of a tree) for the hydrophilic moiety and other required functional moieties. A macromolecule of this type will thus have repeated hydrophilic branches extending in one direction (e.g. “up”) and, optionally, repeated hydrophobic branches extending in another direction (e.g. “down”). With reference to the three-dimensional structure of the macromolecules, it will be understood that the embodiment including hydrophilic and hydrophobic functionalities, either or both of may extend in more than one direction.

### Moieties Capable of Crosslinking the Coating Material

The moieties capable of crosslinking the coating material can be comprised in the macromolecular scaffold or can be a further functional moiety attached to the macromolecular scaffold.

An advantage of forming a macromolecular scaffold comprising Michael type reactive groups which are capable of taking part in a Michael type reaction is that the same macromolecular scaffold may be used as the intermediate for a variety of macromolecules, with each macromolecule having a different functionality depending upon its specific application.

Through these Michael type reactive groups, the macromolecular scaffold may be loaded with polymerisable moieties which are capable of UV cross-linking.

A particular advantage is attained by attaching the aforementioned molecular scaffold with a moiety capable of crosslinking, e.g. free olefinic groups. The coating material comprising the macromolecule can be applied onto a substrate in an aqueous environment—where it will assume a conformation such as to have the hydrophilic moieties extend into the environment, and the other, preferably hydrophobic, moieties bond to the surface of the substrate—and then be crosslinked. This is used to yield a firmer structure coating the substrate. Further in embodiments in which the coating material comprises other components, the cross-linking moiety may be used to reduce the level of extractables from the coating. For example, in a special embodiment, the coating material further comprises nanoparticles grafted with a moiety capable of bonding to the macromolecule. An advantage of this embodiment is that nanoparticles are added in sufficient quantities to improve mechanical properties, but in not high enough concentrations such that cracking and delamination of the coating occurs. Therefore, the % wt of nanoparticles, relative to the total mass of the dry coating composition (i.e coating composition, excluding solvents) is preferably less than 50 wt %, more preferably less than 30 wt %, even more preferably less than 15 wt % and most preferably less than 10 wt %. Preferably, the % wt of nanoparticles, relative to the total mass of the dry coating composition, is at least 0.5 wt %, more preferably at least 1.0 wt %, and even more preferably at least 5 wt. % Nanoparticles are required at these minimum levels to contribute to the functionality of the coating material. Further details relating to suitable nanoparticles which may be incorporated in the coating material of the present invention may be found in WO2006/016800.

As an alternative to incorporating nanoparticles into the cured coating material, nanoparticles may also be incorporated into the functional moiety of the macromolecules, with the nanoparticle forming part of a hybrid (organic-inorganic) compound comprising a Michael type reactive groups so to enable the compound to be attached to the molecular scaffold through a Michael type reaction.

In a preferred embodiment, the attached moiety is capable of cross-linking the macromolecules to other macromolecules or components of the coating material.

In a more preferred embodiment the macromolecule comprises a moiety that is capable of being crosslinked, preferably by radiation curing, more preferably by UV radiation. Typically, these moieties comprise Michael type acceptors, such as acrylates and/or methacrylates, but other moieties may also comprise non-Michael type reactive groups including vinyl ethers, allyl ethers, styrenics and combinations thereof.

Suitable examples of (meth)acrylate compounds for use as polymerisable moieties, or as Michael type acceptors forming part of the molecular scaffold or functional moieties are: 2-hydroxyethyl(meth)acrylate, 2-hydroxypropyl(meth)acrylate, 2-hydroxybutyl(meth)acrylate, 2-hydroxy-3-phenyloxypropyl(meth)acrylate, 1,4-butanediol mono(meth)acrylate, 2-hydroxyalkyl(meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, diethylene glycol di(meth)acrylate, triethylene glycol di(meth)acrylate, dipropylene glycol di(meth)acrylate, and bis(2-hydroxyethyl)isocyanurate di(meth)acrylate; poly(meth)acrylates prepared by adding ethylene oxide or propylene oxide to the hydroxyl group of these (meth)acrylates; and oligoester (meth)acrylates, oligoether (meth)acrylates, oligourethane (meth)acrylates, and oligoepoxy(meth)acrylates having two or more (meth)acryloyl groups in the molecule, N-vinyl pyrrolidone, N-vinyl caprolactam, vinyl imidazole, vinyl pyridine; acryloyl morpholine, (meth)acrylic acid, caprolactone acrylate, tetrahydrofurfuryl(meth)acrylate, butoxyethyl(meth)acrylate, ethoxydiethylene glycol (meth)acrylate, phenoxyethyl(meth)acrylate, polyethylene glycol mono(meth)acrylate, polypropylene glycol mono(meth)acrylate, methoxyethylene glycol (meth)acrylate, ethoxyethyl(meth)acrylate, methoxypolyethylene glycol (meth)acrylate, methoxypolypropylene glycol (meth)acrylate, diacetone (meth)acrylamide, beta-carboxyethyl(meth)acrylate, phthalic acid (meth)acrylate, isobutoxymethyl (meth)acrylamide, N,N-dimethyl(meth)acrylamide, t-octyl(meth)acrylamide, dimethylaminoethyl(meth)acrylate, diethylaminoethyl(meth)acrylate, butylcarbamylethyl (meth)acrylate, n-isopropyl(meth)acrylamide fluorinated (meth)acrylate, 7-amino-3,7-dimethyloctyl(meth)acrylate, N,N-diethyl(meth)acrylamide, N,N-dimethylaminopropyl(meth)acrylamide, hydroxybutyl vinyl ether, ethylene glycol vinyl ether, diethylene glycol divinyl ether, and triethylene glycol vinyl ether and compounds represented by the following formula (I)

CH₂═C(R¹)—COO(R²O)ₘ—R⁸ Formula I

wherein R¹ is a hydrogen atom or a methyl group; R² is an alkylene group containing 2 to 8, preferably 2 to 5 carbon atoms; and m is an integer from 0 to 12, and preferably from 1 to 8; R³ is a hydrogen atom or an alkyl group containing 1 to 12, preferably 1 to 9, carbon atoms; or, R³ is a tetrahydrofuran group-comprising alkyl group with 4-20 carbon atoms, optionally substituted with alkyl groups with 1-2 carbon atoms; or R³ is a dioxane group-comprising alkyl group with 4-20 carbon atoms, optionally substituted with methyl groups; or R³ is an aromatic group, optionally substituted with C₁-C₁₂ alkyl group, preferably a C₈-C₉ alkyl group, and alkoxylated aliphatic monofunctional monomers, such as ethoxylated isodecyl(meth)acrylate, ethoxylated lauryl(meth)acrylate, and the like.

UV curing and photoinitiators used therein, are known to the skilled artisan.

### Controlling the Extent of Cross-Linking

In a preferred embodiment, the proportion of Michael type reactive sites, which are capable of cross-linking, on the macromolecular scaffold is such that after completion of the Michael type reaction with the functional moieties, there is at least 1 and preferably at least 2 residual Michael type reactive groups remaining. This ensures that during the curing step there are sufficient Michael type reactive groups which are capable of cross linking to enable that the macromolecular scaffolds in the coating composition form an integral network having low levels of leachability.

For Michael type acceptors capable of participating in two successive Michael type reactions (e.g. primary amines and phosphine etc), the preferred molar proportion of Michael type donors (n_{donors}) to Michael type acceptors (n_{acceptors}) may be expressed as:

n_{donors}=(n_{acceptors}−X)/2

wherein X is at least 1 and more preferably at least 2.

For Michael type acceptors only capable of participating in a single Michael type reaction, the preferred molar proportion of Michael type donors (n_{donors}) to Michael type acceptors (n_{acceptors}) may be expressed as:

n_{donors}=n_{acceptors}−X

wherein X is at least 1 and more preferably at least 2.

Unreacted Michael type acceptor or Michael type donor groups on the macromolecular scaffold may be as a connection point from which to use the Michael reaction to add a further component having the same or different functionality.

In embodiments in which the Michael reaction results in the attachment of a compound having the same or similar functional groups, the Michael reaction is used as a chain extender to reposition the functional group (i.e to the peripheral portion of the macromolecule), such that the functionality of the macromolecule or coating comprising thereof has enhanced functionality. For example, the chain length of an acrylate group may influence the ability of the group to function as a cross-linking agent with adjacent macromolecules.

### Special Embodiment

In a special embodiment of the present invention, the molecular scaffold is prepared by a method comprising the step of:
a) providing an addition product of an α,β-olefinically unsaturated compound and an amine comprising at least two hydroxyl groups.
   Preferably, the molecular scaffold is further modified by the step of:
b) esterifying at least part of the hydroxyl groups of the addition product with an olefinically unsaturated compound, in particular an olefinically unsaturated carboxylic acid, an olefinically unsaturated carboxylate, an olefinically unsaturated carboxylic acid anhydride, an ester of an olefinically unsaturated carboxylic acid, or an olefinically unsaturated acid halogenide.

It is preferred that the amount of the hydroxyl functional amine added in step ‘a’ should be in stoichiometrical deficient ratio with the number of olefinically unsaturated groups in the olefinically unsaturated compound. This results in the required formation of Michael type acceptor groups on the macromolecular scaffold which are capable for participating in Michael type reactions for the additional of a functional moiety, including the hydrophilic moiety.

In a special embodiment, the molar ratio of amine to olefinically unsaturated carboxylic acid is at less than 0.99, in particular less than 0.98 more in particular less than 0.95, even more in particular less than 0.90 or at less than 0.85. The ratio is usually at least 0.5, in specific embodiment it may be as low as 0.3 or even down to 0.1. By controlling the molar ratio of amine to olefinically unsaturated carboxylic acid in addition to controlling the molar amounts of functional moieties comprising Michael type donor groups, the resulting architecture of the macromolecules of the present invention, may be controlled and customised to the required functional requirements.

The addition product from step ‘a’ is used to prepare a branched macromolecular scaffold in step ‘b’ by esterifying the hydroxy groups of the addition product with an olefinically unsaturated carboxylic acid (or derivative thereof). The resultant olefinically unsaturated ester formed in step ‘b’, can undergo a (further) Michael-type addition reaction with an amine comprising at least two hydroxyl groups in further step ‘a’. The resultant addition product can be esterified as before in a further step ‘b’. Thus it is possible to increase the number of functional groups (unsaturated groups/hydroxyl groups) with each cycle of reactions ‘a’ and ‘b’ to thereby produce a macromolecular scaffold with the required number of reactive sites which are capable of Michael type addition of a hydrophilic moiety and other functionality moiety and which is able to cross-link upon curing of the coating composition.

In a preferred aspect of this embodiment, the amine of step a) is represented by the formula:

R^{x}—NH—R^{y},

wherein R^{x} and R^{y} are independently selected from the group of hydroxylated hydrocarbons.

Preferably, R^{x} and/or R^{y} is independently selected from hydroxy-alkyl moieties and polyether-ol moieties.

In a particularly preferred aspect of this embodiment, suitable olefinically unsaturated compounds that may form the core of macromolecules of the invention may be selected from the group consisting of: (poly)ethylene glycol di(meth)acrylates and (poly)propylene glycol di(meth)acrylates. Such compounds advantageously produce liquid macromolecules of low viscosity for a given molecular mass and/or which exhibit good adhesion properties. Such macromolecules may be diluted with water, if desired, to further reduce viscosity.

Convenient multi-functional (e.g. di, tri or tetra or higher functional) olefinically unsaturated compounds which may be used as a core molecule may comprise:
dipropylene glycol diacrylate (DPGDA),
tripropylene glycol diacrylate (TPGDA),
diethyleneglycol diacrylate,
di(meth)acrylates of aliphatic diols, such as 1,6-hexanediol di(meth)acrylate, neopentylglycol diacrylate (NPGDA), and/or butanediol diacrylate (BDDA).
bisphenol A di(meth)acrylate,
ethoxylated and/or propoxylated bisphenol A di(meth)acrylate,
neopentylglycol di(meth)acrylate,
ethoxylated and/or propoxylated neopentylglycol di(meth)acrylate.
trimethylpropane tri(meth)acrylate;
alkoxylated (e.g. ethoxylated and/or propoxylated) trimethylpropane tri(meth)acrylate;
glycerol tri(meth)acrylate;
alkoxylated (e.g. ethoxylated and/or propoxylated) glycerol tri(meth)acrylate;
tris(hydroxyalkyl)isocyapurate tri(meth)acrylates, such as those where the hydroxyalkyl is 2-hydroxyethyl;
pentaerythritol tri(meth)acrylate;
alkoxylated (e.g. ethoxylated and/or propoxylated) pentaerythritol tri(meth)acrylate;
pentaerythritol tetra(meth)acrylate;
dipentarythritol hexa(meth)acrylate;
alkoxylated (e.g. ethoxylated and/or propoxylated) pentaerythritol tetra(meth)acrylate.

Compounds with four (meth)acrylate groups may provide an ester (as core molecule) that has four unsaturated bonds that can take part in the Michael-type addition.

Further details relating to this special embodiment may be found in WO2009/037345, in particular preferred olefinally unsaturated carboxylic compounds used in process step (b) are included on page 6, lines 19 to 33.

The present invention also covers molecular scaffolds produced according to the above process.

Whilst the foregoing refers to a divergent synthesis, the skilled person will understand that the dendritic polymers suitable for use in the present invention can also be synthesized in a convergent way. This refers to a synthesis starting from the periphery, i.e. preferably from PEO.

In another preferred embodiment, the dendritic polymer used in this embodiment of the invention is based on a hyperbranched polyester amide.

Hyperbranched polyesteramides having various cores and various end groups suitable for the purpose of the present invention are disclosed in WO1999/016810, WO2000/056804, WO2000/058388, WO2003/097959 and WO2007/098889.

Hyperbranched polyesteramides having alcohol end groups or modified end groups suitable for the purpose of the present invention are disclosed in WO1999/016810, in particular page on 1 to page 16 which is included herein by reference.

Hyperbranched polyesteramides having esteralkylamide-acid end groups or modified end groups suitable for the purpose of the present invention are disclosed in WO2000/056804, in particular page on 1 to page 10 which is included herein by reference.

Hyperbranched polyesteramides having dialkylamide end groups suitable for the purpose of the present invention are disclosed in WO2000/058388, in particular page on 1 to page 12 which is included herein by reference.

Hyperbranched polyesteramides at which hydroxyl functional compounds, like polyethylene glycol or polypropylene glycol are incorporated as end groups suitable for the purpose of the present invention are disclosed in WO2003/097959, in particular page on 1 to page 3 which is included herein by reference.

Hyperbranched polyesteramides having heterocyclic end groups suitable for the purpose of the present invention are disclosed in WO2007/098889, in particular page on 1 to page 19 which is included herein by reference.

In case any the hyperbranched polyamides contain tertiary amine groups these might be protonised by various acids or quaternised with customary quaternising agents according to standard procedures as e.g. described in Jerry March, Advanced organic chemistry, 4^{th} edition, Wiley-Interscience p. 411ff.

Combinations of various different of the above described end groups in one hyperbranched polymer are also possible.

The macromolecules suitable for use in the invention serve as coating materials. To this end, these macromolecules preferably have suitable film-forming characteristics.

The invention includes macromolecules comprising hydrophilic and hydrophobic polymer branches. Preferably, the novel dendritic polymer comprises a hydrophobic core and a hydrophilic periphery.

The coating material can be applied onto a substrate using various wet coating techniques. E.g., spray-coating, dip-coating, ink-printing, spraying on a molder prior to molding a substrate, optionally using polymer blending prior to molding a substrate.

### System for Customising the Functionality of a Coating Material

In another embodiment of the present invention, there is provided a system for customising the functionality of a coating material comprising the steps of:
(A) providing a coating material as previously described, wherein the macromolecule comprises at least one reactive group capable of undergoing a Michael type reaction between a Michael type acceptor group and a Michael type donor group;
(B) evaluating the functional performance of the coating material against a predetermined specification;
(C) adding a functional moiety to react with at least a portion of the at least one reactive group, based upon the evaluated functional performance in step (B); and
(D) repeating steps (B) and (C) until the functional performance of the coating material satisfies the predetermined specification.

The system advantageously enables coating materials to be customised to the needs of a particular application. Furthermore, the system enables the coating material to be adjusted for variations or changes in the process, which may occur by design (e.g. change of substrate) or due to unregulated changes in the process (out of specification substrate or biofouling fluid). The ability to optimise the functionality of the specific conditions experienced in use enables greater coating performance. Indeed, rather than coating specification being based upon structural criteria (e.g. composition), coating formulation are able to be customised to satisfy specified functional properties, thereby providing end-users with greater confidence in performance. This is particularly important in biomedical applications in which failure to meet functional requirements can have serious consequences.

To enable macromolecules of the present invention to be customised, the macromolecular scaffold preferably comprises an excess of Michael type reactive sites relative to the intended amount of functional moieties, thereby ensuring that the resulting macromolecule has at least one Michael type reactive groups, such that the functionality of the macromolecule can be further adjusted by adding further functional moieties. Indeed, a macromolecular scaffold with a high number of Michael type reactive groups has the advantage of being able to be used for a variety of applications, given that the macromolecular scaffold need not be limited by a pre-specified number of Michael reactions which are required for attachment of the at least one functional moiety.

### Substrates

The surfaces to be coated in the present invention can be a great many different types, i.e. anything used in possible contact with biofluid. Generally this refers to metal, synthetic materials such as plastics, and glass. Metals comprise all types of metals, including alloys and metal oxides. Plastics comprise polyolefins, polyesters, polyamides, polyurethanes, polysulfones, polycarbonates, fluoropolymers, silicon elastomers, any copolymers. Glass typically refers to float glass, borosilicate glass or the like.

A wide variety of substrates may be used as a substrate in the process according to the invention. Suitable substrates are for example flat or curved, rigid or flexible substrates including films of for example polyolefins such as polyethylene (PE), low density polyethylene (LDPE), linear low density polyethylene (LLDPE), ultra high molecular weight polyethylene (UHMWPE), high density polyethylene (HDPE), crosslinked polyethylene (XLPE), polypropylene (PP), polymethylpentene (TPX), polybutylene (PB), polyisobutene (PIB), polystyrene (PS), polyvinyl chloride (PVC), polyvinylidene chloride (PVDC), polynorbornene. Polyarylates such as polymethyl methacrylate (PMMA), polymethyl acrylate (PMA), hydroxyethyl methacrylate (HEMA), polybutadiene acrylonitrile (PBAN), polyacrylamide (PAM), polyphenylene sulfide (PPS), polyphenylene ether (PPO). Polyesters such as polyethylene terephthalate (PET), polybutylene terephthalate (PBT), poly(cyclohexylene dimethylene terephthalate) (PCTA), polycyclohexylenedimethylene terephthalate glycol (PCTG), polyethylene terephtalate glycol (PETG), polytrimethylene terephthalate. Polysulphones such as polysulfone (PSU), polyarylsulfone (PAS), polyethersulfone (PES), polyphenylsulfone (PPS). Polyamides such as PA11, PA12, PA 66, PA6, PA46, PA6-co-PA66, PA610, PA69, polyphthalamide (PPA), bismaleimide (BMI), urea formaldehyde (UF). Cellulosics such as cellulose acetate, cellulose acetate butyrate, cellulose acetate propionate, ethyl cellulose, cellulose propionate. Polyurethanes such as polyurethane (PU), polyisocyanurate (PIR). Fluoropolymers such as fluoropolymer (FE), polytetrafluoroethylene (PTFE), ethylene chlorotrifluoroethlyene (ECTFE). Polycarbonate (PC), polylactic acid (PLA), polyimide, polyetherimide, polyetheretherketone (PEEK), polyetherketon (PEK), polyestercarbonate. Copolymers such as acrylonitrile butadiene styrene (ABS), ethylene vinyl acetate, ethylene vinyl alcohol, ethylene N-Butyl Acrylate, polyamide-imide or amorphous solids, for example glass or crystalline materials, such as for example silicon or gallium arsenide. Metallic substrates such as titanium and steel may also be used.

Preferred substrates include polypropylene, polyethylene, polystyrene, polyethylene terephthalate, polycarbonate, polyester, polyvinyl acetate, polyvinyl pyrollidone, polyvinyl chloride, polyimide, polyethylene naphthalate, polytetrafluoro ethylene, nylon, silicone rubber, polynorbornene, glass, titanium, steel, and combinations thereof.

The substrates are preferably able to be molded into, for example, biological sample (e.g. blood) collection tubes, microtitre plates, microfluid devices, biosensors, cell culture flasks and dishes, microtubes, PCR tubes, separation filters, and pipette tips.

Preferably, the surfaces to be coated are synthetic, hydrophobic surfaces. A hydrophobic surface in the context of the invention can be recognized as having a contact angle with water of greater than 45°, and more typically greater than 90°.

The invention includes a hydrophobic surface when provided with a hydrophilic coating comprising a dendritic molecule as described hereinbefore.

The surfaces can belong to any object to be used in contact with biofluid, of such a variety as including large structures such as ships' hulls to small structures such as catheters. The invention is particularly suitable for use with laboratory devices, e.g. pipettes, tubing, containers, etc., such as various laboratory collection and specimen tubes, medical collection tubes, microtiter plates, microfluid chips, medical devices, and biosensors. The invention is particularly applicable to disposable devices.

Applications of the coating include coatings with anti-biofouling or anti-thrombogenic properties, coatings with anti-inflammatory properties, anti-microbial coatings, coatings to prevent biofilm formation, coatings for bioreceptors, coatings for biosensors, haemo-repellent coatings for blood collection tubes and blood contact devices coatings with anti-fogging properties. It is also possible that the coating is applied to an object to enhance wetting by aqueous solutions of the object.

The present coatings may be advantageously used for biological sample (e.g. blood) collection tubes, microtitre plates, microfluid devices, biosensors, cell culture flasks and dishes, microtubes, PCR tubes, separation filters, pipette tips, and the like.

The present coatings may also be used for medical devices such as catheters, implants, stents, and the like.

Preferred uses for the present coatings include blood collection tubes (e.g. Vacutainers®) and microtitre plates.

With this process various coating compositions may be obtained, suitable for all kind of applications.

The biofouling against which the coating material of the invention provides protection can be of a great variety as well. This refers to, generally, the non-specific adhesion of proteins, peptides, nucleic acids, cells, enzymes, antibodies, bacterial mixtures of the foregoing, blood, urine, saliva. The biofluid can be just natural water, e.g. as encountered by the underwater part of ships' hulls, it can be any body fluid during in vivo application of a medical device, or any body fluid when used ex vivo or when used in vitro. Or it can be any, generally aqueous, solution or suspension comprising biomolecules, e.g. for testing purposed in diagnostic, analytical, or synthetic laboratories.

When applied as an anti-biofouling coating, the macromolecules of the invention serve to reduce, and preferably inhibit, the non-specific adsorption of biomaterial to the coated surface. This means that, when compared to non-specific biomaterial adsorption on an uncoated surface, a lower concentration of biomaterial is adsorbed. Preferably, this relative reduction is more than 80%, more preferably more than 90%, and most preferably more than 95%. This can be determined in a simple test, providing an aqueous fluid comprising a solution or suspension of a known biomolecule, e.g. a protein, immersing, in a standardized dimension, the surface to be tested, in the fluid for a standardized period of time, removing the surface from the fluid, and determining the remaining concentration of the biomolecule in the fluid.

In the foregoing, the macromolecules suitable for use in the invention are mostly referred to as comprising hydrophobic moieties for attachment to a surface. A further advantage of using macromolecules in anti-biofouling coatings is the great versatility of the materials that can be provided. Thus, also concepts such as coupling agents and ionic bonding can be incorporated into macromolecules.

A general advantage to macromolecules with a view to anti-biofouling is the high density of hydrophilic moieties that can be included. This compares favourably to e.g. block copolymers comprising these same hydrophilic moieties.

In this respect, the invention also provides the use of a film-forming composition comprising a macromolecule as an anti-biofouling coating, particularly a macromolecule as described hereinbefore, preferably provided with terminal PEO chains.

The invention also resides in a method for providing a substrate with a non-biofouling coating, comprising the following steps:
(a) providing a film-forming formulation comprising a coating material as previously described;
(b) applying the formulation to a substrate using any suitable application method, e.g. spray-coating, dip-coating, aspiration coating, ink-coating
(c) evaporating substantially all volatiles;
(d) cross-linking using any suitable cross-linking technique like UV curing, electronbeam curing, thermal curing.

It will be understood that general technology to provide film-forming formulations (coating compositions) are known. The aforementioned formulations will typically comprise a macromolecule as described hereinbefore, and a suitable solvent or diluent.

The invention will be further explained by the examples, without being limited thereto.

### EXAMPLES

### Examples 1-6 and Comparative Experiments A, B and C

### Materials

Jeffamine® M-1000 (Huntsman) is polyether monoamine of approximately 1 kDa, with a propyleneoxide(PO)/ethyleneoxide(EO) ratio of 3/19. The solvents, toluene, and methanol were purchased from Merck Chemicals. The radical initiator 1-hydroxycyclohexyl phenyl ketone was obtained from Sigma Aldrich.

Hyperbranched acrylate functional oligomers based on 1,6-hexanediol diacrylate (HDDA) and hyperbranched trimethylolpropane(15)ethoxylated triacrylate (TMPEO) were prepared by DSM according to the methods described in WO2009/037345. These hyperbranched acrylate functional oligomers were prepared via Michael additions, resulting in hyperbranched polyesteramine acrylates. The first step of the reaction was the Michael addition of diethanolamine to the acrylates of the HDDA or TMPEO core, followed by the condensation of acrylic acid with the newly introduced hydroxyl groups (Scheme 1). The branching can occur by the same means again on the newly formed acrylate, resulting in a higher overall degree of branching. The product of the hyper-branching of TMPEO was determined to contain on average 6.2 acrylates per molecule, and for hyperbranched HDDA this value was an average of 6.4 acrylates per molecule.

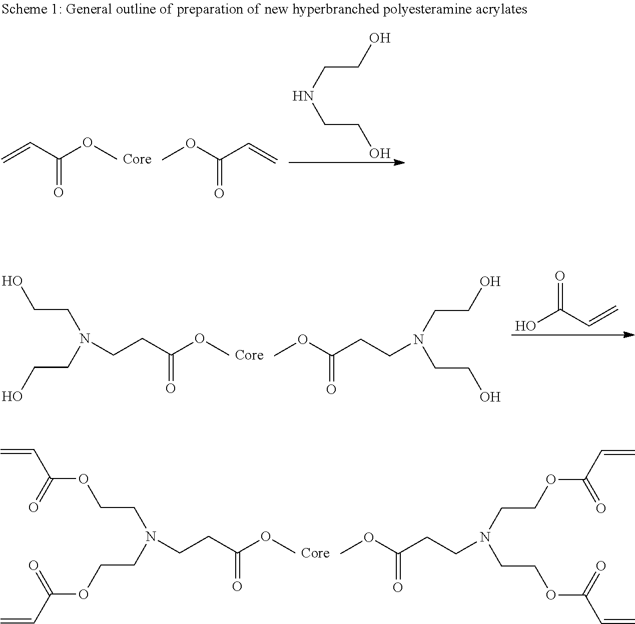

### Synthesis of Hyperbranched Polymer with Michael Addition of Jeffamine® M-1000

The reaction was performed with varying amounts of Jeffamine M-1000 amount. 10 g of hyperbranched HDDA was dissolved in 100 mL toluene. The selected amount of Jeffamine® M-1000 was dissolved in toluene and then added dropwise to the HDDA while stirring at room temperature for 5 minutes. Afterwards the reaction mixture was stirred for 15 hours at room temperature. Then the toluene was evaporated and the product was dried in an oven at 50° C. at reduced pressure. The same reactions were performed for the hyperbranched TMPEO. See Table 1 for the details.

TABLE 1
Ratio of hyperbranched polymer vs. Jeffamine M-100

| | Ratio of | | |
|---|---|---|---|
| | Hyperbranched | | |
| Example/ | polymer/Jeffamine | | |
| Experiment | (mol/mol) | | |
| | | | Jeffamine ® |
| | | TMPEO (g) | M-1000 (g) |
| B | 0% | 5 | 0.00 |
| 1 | 10% | 4 | 1.26 |
| 2 | 20% | 3.5 | 2.20 |
| 3 | 30% | 3 | 2.82 |
| | | | Jeffamine ® |
| | | HDDA (g) | M-1000 (g) |
| C | 0% | 10 | 0.00 |
| 4 | 10% | 10 | 4.95 |
| 5 | 20% | 10 | 9.90 |
| 6 | 30% | 10 | 14.8 |

Coating on PET film

A polyethylene terephthalate (PET) film (5 cm×15 cm) was washed with ethanol and subsequently extensively rinsed with dH₂O. Then the film was dried with a N₂-flow.

The cleaned film was dip-coated in a formulation composed of 2 w/v % of one of the above synthesized hyperbranched polymer in methanol and with 2 mol % 1-hydroxycyclohexyl phenyl ketone (photo initiator to acrylate functionalities). The dip-coating withdrawal speed was set to 17 seconds per centimetre and the samples were cured on the UV-RIG (1 J/cm² each side) directly after coating. For comparative result of various percentage of Jeffamine® M-1000 Michael addition Jeffamine® M-1000 hyperbranched TMPEO the same formulation type was used.

### Coating in PET Tube

The PET tubes were cut at a length of 4 cm. Prior to coating, the tubes were washed with MeOH and subsequently rinsed with dH₂O. After the tube was completely filled with formulation, the formulation was aspirated at a controlled constant speed via a thin steel needle. After the formulation was withdrawn, the suction of the needle was kept for 10 more seconds. The coating was air dried during 5 minutes, whereafter the coating was crosslinked by exposure to UV (2×1 J/cm²) by Macam Flexicure Controller (UVL5101-8 2102).

### Radio-Labelled BSA Adsorption Test in PET Tubes

For the protein adsorption experiments ¹²⁵I Bovine Serum Albumin (37.0-185 kBq/μg) was ordered from Perkin Elmer.

¹²⁵I-BSA buffer solution: The ¹²⁵I-BSA was diluted in a phosphate buffer with unlabelled BSA (40 mM K₂HPO₄, 10 mM NaH₂PO₄.2H₂O, 150 mM NaCl, 0.15 μM BSA, pH 7.4) to 74 kBq/mL.

750 μL of ¹²⁵I-BSA buffer solution was added to PET tubes. The tube was incubated for 20 hours at room temperature. Then the solution was removed with a pipette and the tube was washed with 1000 μL dH₂O three times. After washing, the tube was placed in an empty 20 mL liquid scintillation counter (LSC) vial. This vial was filled with 20 mL of Pico-Fluor 15 LSC cocktail. Then liquid scintillation counting was performed with Packard Liquid Scintillation Analyzer 1900TR. Uncoated tube was measured as a reference sample and also the background radioactivity was determined. Five parallel samples were tested, and the averaged result is used.

### Steel Wool Test

This test is referred to as steel wool abrasion. In this test steel wool of 0000 grade is pressed against the coated surface (1 inch) assure of about 250 grams. The sample is oscillated in a straight line under the weighted steel wool for 10 cycles (5 cm forward and 5 cm backward is one cycle). The surface is then visually inspected for scratching. The results are categorized as A, B, C, D and E. No scratches are visual for A, and coating is completely scratched or even removed for E.

TABLE 2
125-I BSA absorption and steel wool testing results of various
degrees of Jeffamine on two types of hyperbranched polymers.

| Example/ | Sample | 125-1 BSA | Steel wool |
|---|---|---|---|
| Experiment | description | adsorption % | grade |
| A | Uncoated tube | 100% | — |
| B | Hyperbranched | 12% | B |
| | TMPEO-0% | | |
| 1 | Hyperbranched | 3.5% | D |
| | TMPEO-10% | | |
| 2 | Hyperbranched | 10.2% | E |
| | TMPEO-20% | | |
| 3 | Hyperbranched | 14.5% | E |
| | TMPEO-30% | | |
| C | Hyperbranched | 30.1% | B |
| | HDDA-0% | | |
| 4 | Hyperbranched | 5.7% | D |
| | HDDA-10% | | |
| 5 | Hyperbranched | 15.8% | E |
| | HDDA-20% | | |
| 6 | Hyperbranched | 20.2% | E |
| | HDDA-30% | | |

As can be seen form the results in table 2, addition of the Jeffamine to the hyperbranched acrylic cores result in a dramatic reduction of protein adsorption. At ca 10 mol-%, protein adsorption is minimised while the remaining acrylic groups facilitate acceptable mechanical durability. (see Steel wool resistance).

1. A coating material suitable for providing a substrate with an anti-biofouling coating, the coating material comprising a macromolecule comprising:
(A) a macromolecular scaffold comprising a reactive group capable of undergoing a Michael type reaction between a Michael type acceptor group and a Michael type donor group,
(B) at least one functional moiety attached to the macromolecular scaffold, said at least one functional moiety comprising a hydrophilic moiety, wherein the functional moiety is derivable from a Michael type reaction, involving the reactive group on the macromolecular scaffold and a reactive hydrophilic moiety and
(C) at least one moiety capable of crosslinking the coating material.

2. The coating material according to claim 1, wherein the moiety capable of crosslinking the coating material is comprised in the macromolecular scaffold or is a further functional moiety attached to the macromolecular scaffold.

3. The coating material according to claim 1, wherein the reactive hydrophilic moiety comprises a hydrophilic moiety and a Michael type donor group and the reactive group on the macromolecular scaffold comprises a Michael type acceptor group.

3. The coating material according to claim 1, wherein the Michael type donor group comprises a donor atom selected from a group consisting of nitrogen, phosphorous, arsenic, oxygen, sulphur, tin, selenium and combinations thereof.

4. The coating material according to claim 1, wherein the reactive hydrophilic moiety comprises:
(A) a reactive portion comprising a Michael type donor group comprising a nitrogen donor atom; and a
(B) hydrophilic portion comprising a poly(ethylene oxide) group located in the peripheral portion at an opposing end to the donor group.

5. The coating material according to claim 1, wherein the proportion of Michael type acceptor groups to Michael type donor groups on the macromolecular scaffold and reactive hydrophilic moieties is such that upon completion of the Michael type reaction involving the macromolecular scaffold and reactive hydrophilic moieties, the macromolecule comprises at least one residual Michael type reactive group capable of cross-linking the coating composition.

6. A coating material according to claim 1, wherein the macromolecular scaffold comprises building blocks based on cyclic anhydride or dicarboxylic acid, and hydroxy alkyl amine and/or ester branching groups.

7. The coating material according to claim 1, wherein the macromolecular scaffold is derivable from an olefinically unsaturated compound and an amine comprising at least two hydroxyl groups.

8. The coating material according to claim 8, wherein the amine is represented by the formula:
R^{x}—NH—R^{y},
wherein R^{x} and R^{y} are independently selected from the group of hydroxylated hydrocarbons.

9. A coating material according to claim 1 wherein the hydrophilic moiety comprises hydrophilic polymer branches.

10. An article comprising a non-biofouling coating comprising a coating material according to claim 1.

11. The use of a coating material according to claim 1 in an anti-biofouling coating, wherein the biofouling refers to the non-specific adhesion of proteins, peptides, nucleic acids, enzymes, antibodies, cells and micro-organisms, mixtures of the above and blood.

12. A method for providing a substrate with a non-biofouling coating, comprising the following steps:
(a) providing a film-forming formulation comprising a coating material according to claim 1;
(b) applying the formulation to a substrate;
(c) evaporating substantially all volatiles; and
(d) cross-linking the coating.

13. A system for customising the functionality of a coating material comprising the steps of:
(A) providing a coating material according to claim 1, wherein the macromolecule comprises at least one reactive group capable of undergoing a Michael type reaction between a Michael type acceptor group and a Michael type donor group;
(B) evaluating the functional performance of the coating material against a predetermined specification;
(C) adding a functional moiety to react with at least a portion of the reactive group, based upon the evaluated functional performance in step (B); and
(D) repeating steps (B) and (C) until the functional performance of the coating material satisfies the predetermined specification.

14. The use of a macromolecule as defined in claim 1 in an anti-biofouling coating.
